(19) United States
(12) Patent Application Publication
(10) Pub. No.: US 2005/0059423 A1
(43) Pub. Date: Mar. 17, 2005

(54) Method for outer loop power control when no cyclic redundancy check results are available on the coded composite transport channel

(75) Inventors: Chang-Soo Koo, Melville, NY (US); Sung-Hyuk Shin, Northvale, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/902,744

(22) Filed: Jul. 29, 2004

Related U.S. Application Data
(60) Provisional application No. 60/491,035, filed on Jul. 30, 2003.

(51) Int. Cl. H04B 7/00; H04B 17/00

(52) U.S. Cl. 455/522; 455/67.13

(57) ABSTRACT

A method for outer loop power control in a wireless communication system begins by determining if a cyclic redundancy check (CRC) is available. If the CRC is available, the method uses the CRC to calculate an adjustment for a target signal to interference ratio (SIR) for a coded composite transport channel (CCTrCH). If the CRC is not available, then quality measurements of the CCTrCH are taken. The quality measurements are used to calculate an adjustment for the target SIR, which is then updated.

### CROSS REFERENCE TO RELATED APPLICATION(S)

This application claims the benefit of U.S. Patent Application No. 60/491,035, filed Jul. 30, 2003, which is incorporated by reference as if fully set forth herein.

### FIELD OF INVENTION

The present invention relates to communication systems with power control algorithms, wherein the power control algorithms use measurements other than a cyclic redundancy check.

### BACKGROUND

The third generation wide-band code division multiple access (3G W-CDMA) systems use power control as a link adaptation method. Dynamic power control is applied for dedicated physical channels (DPCHs) such that the transmit power of the DPCHs is adjusted to achieve a quality of service (QoS) with a minimum transmit power level, thus limiting the interference level within the system. The transmit power control of DPCHs can be divided into two processes operating in parallel: inner loop power control (ILPC) and outer loop power control (OLPC). The ILPC algorithm controls transmit power to keep the received signal to interference ratio (SIR) of each DPCH as close as possible to a target SIR. The OLPC algorithm controls the target SIR per coded composite transport channel (CCTrCH) to keep the received quality as close as possible to a target quality, which means that the output of the OLPC is an updated target SIR used for the ILPC.

For both real time (RT) and non-real time (NRT) CCTrCHs, the OLPC algorithms initially set a target SIR according to the required target quality for a given CCTrCH, such as block error rate (BLER), typically using a fixed mapping between BLER and SIR. The OLPC algorithm then adjusts the target SIR using the cyclic redundancy check (CRC) of each transport channel (TrCH) within a given CCTrCH. In other words, the OLPC algorithms check the CRC results on the CCTrCH and adjust the target SIR up or down accordingly. The target SIR value applies to the entire CCTrCH. It is noted that while there may be other approaches for measuring the received quality, using the CRC result is well-known to be a simple and reliable approach.

However, there is the case where no CRC is available for the CCTrCH. This case occurs when there is no TrCH available within the CCTrCH with CRC results or when the CCTrCH is completely absent. The case when the CCTrCH is completely absent is called discontinuous transmission (DTX). In the case where the CRC results are not available or when the CCTrCH is completely absent, the CRC-based OLPC algorithm may not be able to continuously update the target SIR, which may lead to a performance degradation.

### SUMMARY

The present invention presents several methods for the outer loop power control (OLPC) to adjust the target signal to interference ratio (SIR) in the absence of cyclic redundancy check (CRC) results on the coded composite transport channel (CCTrCH). A first method uses the received signal quality measurements instead of the CRC results to adjust the target SIR. A second method holds the target SIR constant if the CRC results are not available. In a third method, the target SIR may revert to the initial outer loop stage depending on the time elapsed.

A wireless transmit/receive unit (WTRU) for use in a wireless communication system includes determining means for determining if a cyclic redundancy check (CRC) is available, measuring means for measuring a quality value of a coded composite transport channel (CCTrCH), calculating means for calculating an adjustment for a target signal to interference ratio (SIR) for the CCTrCH, and updating means for updating the target SIR based upon the calculated adjustment, the target SIR being used for outer loop power control. The calculating means uses the CRC if available and uses the measured quality value if the CRC is not available.

If the CRC is available, the calculating means uses the CRC value. If the CRC is not available, there are three options: the calculating means uses the measured quality value, the calculating means does not operate, or the target SIR is changed to a previously used value or an initial value. If the last option is used, the WTRU will also include changing means for changing the target SIR.

A base station, a radio network controller, and an integrated circuit may also be constructed in a manner similar to that of the wireless transmit/receive unit described above.

### BRIEF DESCRIPTION OF THE DRAWINGS

A more detailed understanding of the invention may be had from the following description of a preferred embodiment, given by way of example and to be understood in conjunction with the accompanying drawings, wherein:

FIG. 1 is a block diagram overview of a wireless transmit/receive unit (WTRU) constructed in accordance with the present invention; and

FIG. 2 is a flowchart of a method for adjusting the target SIR in accordance with the present invention.

### DETAILED DESCRIPTION OF THE PREFERRED EMBODIMENTS

Hereafter, a wireless transmit/receive unit (WTRU) includes, but is not limited to, a user equipment, a mobile station, a fixed or mobile subscriber unit, a pager, or any other type of device capable of operating in a wireless environment. When referred to hereafter, a base station includes, but is not limited to, a Node B, a site controller, an access point, or any other type of interfacing device in a wireless environment.

The present invention presents several methods for the outer loop power control (OLPC) to adjust the target signal to interference ratio (SIR) in the absence of cyclic redundancy check (CRC) results on the coded composite transport channel (CCTrCH). Although described in the context of a 3G W-CDMA environment, the invention is applicable to any environment using OLPC or a variant thereof.

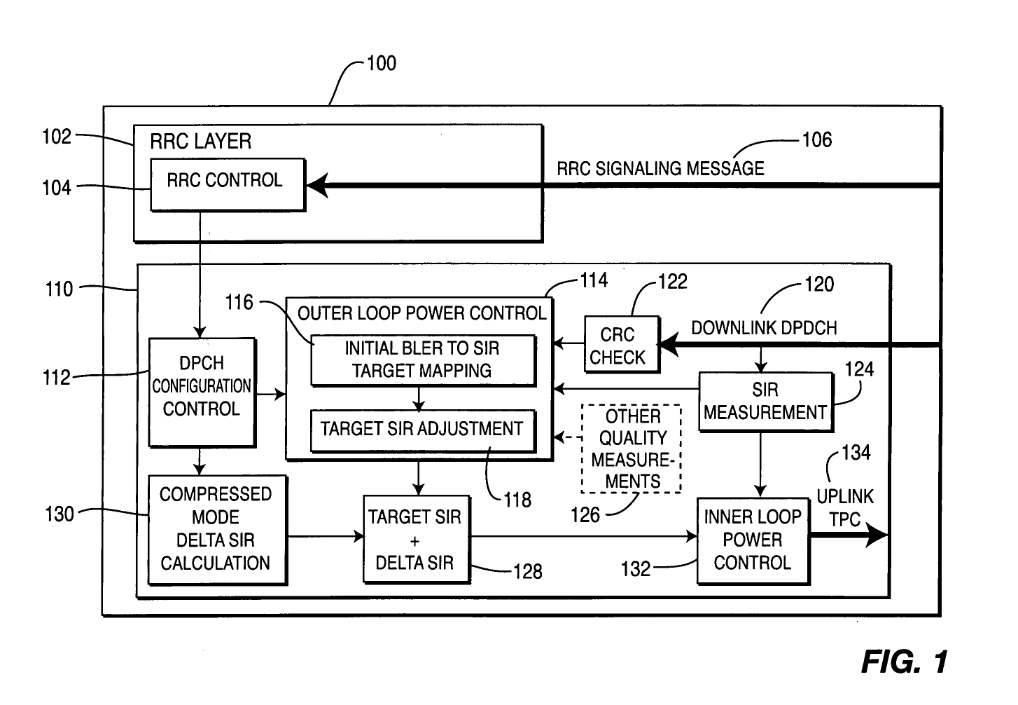

FIG. 1 is a block diagram of a WTRU 100 constructed in accordance with the present invention. The invention can also be applied to a base station or a radio network controller (RNC) for uplink power control; in such circumstances, the description below can be equally applied by interchanging the terms “uplink” and “downlink”. The following components may be implemented as an integrated circuit (IC), such as an application specific IC (ASIC), multiple ICs, discrete components, or a combination of them. The WTRU 100 includes a radio resource control (RRC) layer 102 having a RRC control device 104. A RRC signaling message 106 is received by the RRC control device 104 from a RNC via a base station (Node B) that is in communication with the WTRU 100.

The WTRU 100 also includes a physical layer 110, which is controlled/configured by the RRC control device 104. A DPCH configuration control device 112 receives the commands from the RRC control device 104. The DPCH configuration control device 112 provides information to an OLPC device 114, which includes an initial BLER to SIR target mapping device 116 and a target SIR adjustment device 118.

A downlink dedicated physical data channel (DPDCH) 120 is received by the physical layer 110, and contains information used in calculating a CRC by a CRC check device 122 and in measuring the SIR of the channel by a SIR measurement device 124. Both the CRC (if available) and the SIR measurement are passed to the OLPC device 114. Other quality measurements 126 are taken and are passed to the OLPC device 114. The OLPC device accepts inputs from the DPCH configuration control device 112, the CRC check device 122 (if available), the SIR measurement device 124, and other quality measurements 126 and generates a target SIR adjustment, which is sent to a target SIR/delta SIR adder 128.

The adder 128 receives the delta SIR value from a compressed mode delta SIR calculation device 130, which receives information from the DPCH configuration control device 112. The adder 128 provides a SIR adjustment value to an ILPC device 132, which provides a transmit power control command in uplink 134 to be sent to the Node B.

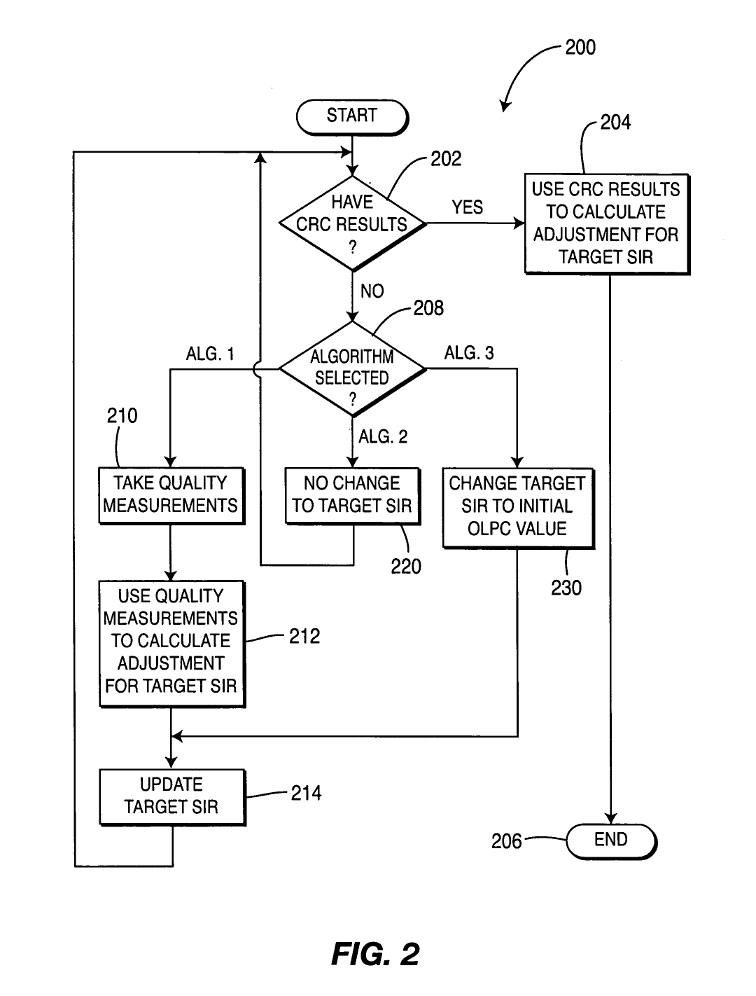

FIG. 2 is a flowchart of a method 200 for adjusting the target SIR value in accordance with the present invention. The method 200 begins by determining whether CRC results are available (step 202). If CRC results are available, then the CRC results are used to calculate the adjustment for the target SIR (step 204) and the method terminates (step 206). If CRC results are not available (step 202), an algorithm is selected for adjusting the target SIR in the absence of CRC results (step 208).

In a first algorithm, quality measurements are taken (step 210). The quality measurements are used to calculate the adjustment for the target SIR (step 212). The target SIR is updated (step 214), and the method returns to step 202 for further updates. The quality measurements are used to indicate the received signal quality of the radio link associated with the CCTrCH. The quality measurements may include the received power measurement of a pilot channel or a raw bit error rate (BER) measurement based on pilot bits or data bits. Channel impulse responses based on a pilot channel can also be also used as a received signal quality measurement.

The OLPC may rely on some other measurement information indicating the received quality of the radio link associated with the CCTrCH, instead of the CRC results. For example, the OLPC can trace radio channel conditions, like channel type and channel variation, from the received signal power measurement or channel impulse response on a pilot channel. The OLPC algorithm then uses the channel information instead for updating the target SIR.

In a second algorithm, no change is made to the target SIR (step 220), and the method 200 will wait until a CRC is received, by returning to step 202. Once the CRC results are available, the OLPC algorithm varies the target SIR based on the CRC results.

In a third algorithm, the target SIR is changed to the initial OLPC value depending on the time elapsed (step 230), the target SIR is updated (step 214), and the method returns to step 202 to wait for a CRC to be received. Once the CRC results are available, the OLPC algorithm varies the target SIR based on the CRC results.

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

1. A method for outer loop power control in a wireless communication system, comprising the steps of:
determining if a cyclic redundancy check (CRC) is available and if the CRC is available, using the CRC to calculate an adjustment for a target signal to interference ratio (SIR) for a coded composite transport channel (CCTrCH);
if the CRC is not available, then
taking quality measurements of the CCTrCH;
using the quality measurements to calculate an adjustment for the target SIR; and
updating the target SIR.

2. A method for outer loop power control in a wireless communication system, comprising the steps of:
determining if a cyclic redundancy check (CRC) is available and if the CRC is available, using the CRC to calculate an adjustment for a target signal to interference ratio (SIR) for a coded composite transport channel (CCTrCH); and
if the CRC is not available, then not applying any change to the target SIR and waiting for a CRC to become available.

3. A method for outer loop power control in a wireless communication system, comprising the steps of:
determining if a cyclic redundancy check (CRC) is available and if the CRC is available, using the CRC to calculate an adjustment for a target signal to interference ratio (SIR) for a coded composite transport channel (CCTrCH); and
if the CRC is not available, then changing the target SIR to one of a previously used value and an initial value.

4. A wireless transmit/receive unit for use in a wireless communication system, comprising:
determining means for determining if a cyclic redundancy check (CRC) is available;
measuring means for measuring a quality value of a coded composite transport channel (CCTrCH);
calculating means for calculating an adjustment for a target signal to interference ratio (SIR) for the CCTrCH, said calculating means using the CRC if available and using the measured quality value if the CRC is not available; and
updating means for updating the target SIR based upon the calculated adjustment, the target SIR being used for outer loop power control.

5. A wireless transmit/receive unit for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available, said calculating means not operating if the CRC is not available; and
updating means for updating the target SIR based upon the calculated adjustment, the target SIR being used for outer loop power control.

6. A wireless transmit/receive unit for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available;
changing means for changing the target SIR to one of a previously used value and an initial value, said changing means operating if the CRC is not available; and
updating means for updating the target SIR, the target SIR being used for outer loop power control.

7. A base station for use in a wireless communication system, comprising:
determining means for determining if a cyclic redundancy check (CRC) is available;
measuring means for measuring a quality value of a coded composite transport channel (CCTrCH);
calculating means for calculating an adjustment for a target signal to interference ratio (SIR) for the CCTrCH, said calculating means using the CRC if available and using the measured quality value if the CRC is not available; and
updating means for updating the target SIR based upon the calculated adjustment, the target SIR being used for outer loop power control.

8. A base station for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available, said calculating means not operating if the CRC is not available; and
updating means for updating the target SIR based upon the calculated adjustment, the target SIR being used for outer loop power control.

9. A base station for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available;
changing means for changing the target SIR to one of a previously used value and an initial value, said changing means operating if the CRC is not available; and
updating means for updating the target SIR, the target SIR being used for outer loop power control.

10. A radio network controller for use in a wireless communication system, comprising:
determining means for determining if a cyclic redundancy check (CRC) is available;
measuring means for measuring a quality value of a coded composite transport channel (CCTrCH);
calculating means for calculating an adjustment for a target signal to interference ratio (SIR) for the CCTrCH, said calculating means using the CRC if available and using the measured quality value if the CRC is not available; and
updating means for updating the target SIR based upon the calculated adjustment, the target SIR being used for outer loop power control.

11. A radio network controller for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available, said calculating means not operating if the CRC is not available; and
updating means for updating the target SIR based upon the calculated adjustment, the target SIR being used for outer loop power control.

12. A radio network controller for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available;
changing means for changing the target SIR to one of a previously used value and an initial value, said changing means operating if the CRC is not available; and
updating means for updating the target SIR, the target SIR being used for outer loop power control.

13. An integrated circuit for use in a wireless communication system, comprising:
determining means for determining if a cyclic redundancy check (CRC) is available;
measuring means for measuring a quality value of a coded composite transport channel (CCTrCH);
calculating means for calculating an adjustment for a target signal to interference ratio (SIR) for the CCTrCH, said calculating means using the CRC if available and using the measured quality value if the CRC is not available; and
updating means for updating the target SIR based upon the calculated adjustment, the target SIR being used for outer loop power control.

14. An integrated circuit for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available, said calculating means not operating if the CRC is not available; and
updating means for updating the target SIR based upon the calculated adjustment, the target SIR being used for outer loop power control.

15. An integrated circuit for use in a wireless communication system, comprising:
determining means for determining if a cyclic redundancy check (CRC) is available;
calculating means for calculating an adjustment for a target signal to interference ratio (SIR) for a coded composite transport channel, said calculating means using the CRC if available;
changing means for changing the target SIR to one of a previously used value and an initial value, said changing means operating if the CRC is not available; and
updating means for updating the target SIR, the target SIR being used for outer loop power control.
